(19) United States
(12) Patent Application Publication
(10) Pub. No.: US 2026/0048694 A1
(43) Pub. Date: Feb. 19, 2026

(54) A DUMP TRUCK BODY

(71) Applicant: AUSTIN ENGINEERING LIMITED, Western Australia (AU)

(72) Inventors: Jamie Vincent Clarke HALL, Western Australia (AU); Deon WESSELS, Western Australia (AU)

(21) Appl. No.: 19/100,911

(22) PCT Filed: Aug. 9, 2023
(86) PCT No.: PCT/AU2023/050748

§ 371 Date: Feb. 3, 2025

(30) Foreign Application Priority Data
Aug. 12, 2022 (AU) 2022902294

(51) Int. Cl. B60P 1/28

(52) U.S. Cl. CPC B60P 1/286

(57) ABSTRACT

A dump truck body for a dump truck includes a tray having a floor and two side walls extending up from the floor, each side wall comprising a forward end and a rear end. The truck body comprises a side strengthening arrangement on each side wall comprising a rib mounted on the side wall towards the forward end. The rib may comprise a first side joined to the side wall, and a second side that is joined to the side wall spaced from the first side. The rib stiffens the side wall to limit deformation thereof when the tray is loaded with particulate material.

### CROSS-REFERENCE TO RELATED APPLICATIONS

This application is a U.S National Stage Entry of International Application No. PCT/AU2023/050748 filed Aug. 9, 2023, which claims priority to Australian Patent Application No. 2022902294 filed Aug. 12, 2022, both of which are hereby incorporated by reference in their entirety.

### FIELD

This invention relates to a dump truck body. It also extends to a dump truck including the dump truck body.

This invention relates particularly but not exclusively to a large-scale mining truck body used on mining trucks in the mining industry. It will therefore be convenient to hereinafter describe this invention with reference to this example application. However, it needs to be clearly understood that the invention is capable of broader application and applies to all dump truck bodies.

### BACKGROUND

Dump trucks or mining trucks are widely used in the mining industry in Australia and in other countries. A dump or mining truck comprises a dump truck body mounted on a chassis having wheels for displacing the dump truck over the ground. The dump truck body comprises a tray for receiving material to be handled mounted on the chassis, a truck cabin, and a hood or canopy extending over the truck cabin for protecting an operator of the dump truck. An example of such a mining truck is illustrated in FIG. 1 of the drawings. Further, FIG. 4 shows the truck body in a tipping configuration in which the dump truck body is pivoted up on the chassis for discharging material from a rear of the tray.

In the prior art, truck bodies comprising an underlying frame are known. One example of this type of truck is a JEC® truck body manufactured by Austin Engineering Ltd. The JEC® truck body has a skeletal frame defining the tray and canopy. Plates of steel are then welded onto the skeletal frame to form a tray wall (including a tray floor) and a hood wall on the hood or canopy. This truck body is illustrated in FIG. 2 of the drawings. Further, a portion of a rail extending along an upper edge of a side wall of the truck body is shown in FIG. 3.

One advantage of a JEC® truck body is that plates of steel forming the tray wall on the skeletal frame can be replaced when they wear out. The plates of steel extend between frame members on the tray and when a plate of steel is worn out, it is delineated and cut off the skeletal frame. The worn steel plate is then replaced by a fresh plate of steel that fills in the gap left by the removed piece of steel while the skeletal frame provides some underlying structural support. This enables mine operators to extend the life of their fleet of truck bodies by replacing the worn sections of the tray wall while the underlying frame preserves the overall structure and strength of the tray under load.

An ability to replace a section of steel plate on a JEC® truck body when it wears out obviates the need to mount replaceable wear liners on the truck body to extend its life. Prior to the JEC® truck body, replaceable wear liners were mounted on the tray extending across its surface area to protect the underlying steel plate of the tray from being worn out in use. When a set of wear liners reaches the end of its service life, the entire set is replaced at the same time, thereby providing the tray with a new lease of life. The liners are not replaced one at a time as they wear out during use.

The shortcomings of replaceable wear liners are well documented and some of these shortcomings are summarized below. The wear liners add substantial weight to the tray (increasing the tare weight) and thereby reduce the weight of payload that can be carried by the tray. Further, the liners (used on earlier truck bodies) reduce the volume of the tray that is available to receive load material. Thus, a tray that does not have replaceable wear liners fitted thereon will have an increased volumetric carrying capacity that can receive a greater payload of load material.

Further, there are dangers posed by stored energy in wear liners which can be released when the wear liner is cut off the tray. Several accidents have occurred, where a worker has been injured by the release of stored energy when a wear liner has been removed.

By contrast, the JEC® truck body removes and replaces a discrete section of the tray wall, (including the tray floor) when it becomes worn to renovate the tray wall and provide a fresh wear surface thereby extending the lifetime of the truck body and providing additional service lifetime. A worn section of the tray wall can be replaced with a fresh section of unworn steel in less time than it typically takes to replace a full wear liner package. Thus, the JEC® truck body confers advantages over the use of replaceable wear liners. Additional benefits conferred by the JEC® truck body include an increase in the payload (that can be carried) due to a saving in overall body weight, i.e. by omitting the additional weight of the service liners and thereby avoiding encroaching on an internal volume of the tray.

A more recent innovation in truck bodies is an ULTIMA® truck body manufactured by Austin Engineering Ltd. The ULTIMA® truck body is different from the earlier JEC® truck body described above because it does not have a separate underlying frame. Instead, it is frameless and is formed from a plurality of steel plates welded together to form a tray for a truck body. Thus, it is the steel plates in the ULTIMA® truck body provide the underlying strength of the truck body.

An advantage of the ULTIMA® truck body is that it weighs less than the earlier JEC® truck body described above (due to the omission of the underlying frame onto which the replaceable sheets of steel are welded). This reduced tare weight enables the truck body to be loaded with a greater payload. The ULTIMA® body (due to the absence of an underlying frame), enjoys a 10-15% saving in the weight of the truck body (when compared with the JEC® truck body when other factors of the truck body such as size and materials are considered) without sacrificing any volume of the payload that can be carried by the truck. The ULTIMA® truck body is designed to provide a certain life cycle and when the truck body wears out the entire truck body is replaced. It does not have individual wear sections that are replaced and is not repaired.

The reference to prior art in the background above is not and should not be taken as an acknowledgment or any form of suggestion that the referenced prior art forms part of the common general knowledge in Australia or in any other country.

### SUMMARY OF THE INVENTION

Applicant recognizes that there are benefits to be obtained by reducing the weight of a truck body, to increase the weight of a payload that can be carried by the truck body. Applicant also recognizes the benefits of maximizing an internal volume of a truck body to enable it to carry an increased volume of payload. Applicant further recognizes the benefits of not having to perform maintenance on a truck body and take it out of service for repairs during its working lifetime.

According to one aspect of the invention there is provided a dump truck body for a dump truck, comprising:
a tray comprising a floor and two side walls extending up from the floor, each side wall comprising a forward end, a rear end, and a top end extending along a top of the side wall from the forward to the rear ends; and
a side strengthening arrangement on each side wall, wherein each side strengthening arrangement comprises a rib mounted on the side wall towards the forward end to stiffen the side wall at its forward end, and
wherein the rib comprises a first side joined to the side wall, and a second side that is joined to the side wall spaced from the first side, and an intermediate section between said first and second sides of the rib that is outward of the side wall, and the first side of the rib extends along the forward end of the side wall, and the second side of the rib extends along the top end of the side wall.

This limits deformation of the side wall at its forward end when the tray is loaded with particulate material. Thus, the side strengthening arrangement enables a lighter (e.g. thinner and more flexible side wall) to be used for the tray than otherwise could be used.

The first side of the rib may extend from a top of the forward end of the side wall a part of the way down the forward end of the side wall. Optionally, the first side of the rib may extend less than three-quarters of the way down the forward end of the side wall.

In at least one embodiment, the first side of the rib may be positioned within a top half of the forward end of the side wall, i.e. the entire first side of the rib may be wholly received and contained within a top half of the forward end of the side wall.

The second side of the rib may extend from the forward end of the side wall a part of the way along the top end of the side wall.

The first side of the rib may be linear, and the second side of the rib may also be linear. The first and second sides of the rib may converge along their lengths in a forward direction. Thus, in at least some embodiments of the invention, the first and second sides of the rib do not extend parallel to each other.

The intermediate section may comprise a web or sheet of material extending between the first and second sides of the rib, and the first and second sides of the rib may extend along opposed edges of the web or sheet of material.

The intermediate section, the first and the second sides and a part of the side wall between the first and second sides, may together define an elongate space therebetween.

The rib may have opposed ends that extend between the first and second sides, and the rib may comprise at least one continuous piece of material in a direction of length from one end to the opposed end.

In at least one embodiment, the web and at least one of the sides may be formed from a single piece of material, e.g. the rib may be formed from a single piece of continuous material.

The elongate space may have open ends, and the side strengthening arrangement may further comprise a rib end cap on at least one open end of the elongate space.

Optionally, the side strengthening arrangement may comprise rib end caps on both ends of the elongate space.

Each rib end cap may be configured to substantially close off an open end of the elongate space.

Each rib end cap may be welded to the intermediate section and the first and second sides of the rib, and the side wall e.g., along its entire peripheral edge.

Further, each rib end cap may be recessed back from an adjacent end of the elongate space, to provide additional room for welding the rib end cap to the intermediate section and the first and second sides of the rib, to increase the strength of the weld.

The side strengthening arrangement may further comprise an external rib reinforcer mounted on and extending across an external surface of the rib. The external rib reinforcer may be called a rib doubler.

The external rib reinforcer may extend across the first or second side of the rib and a part of the intermediate section thereof.

The external rib reinforcer may be welded around its peripheral edge, to the first or second side of the rib, and to the side wall.

Further, the external rib reinforcer may have a plurality of openings formed therein which provide additional length on the external rib reinforcer for welding the external rib reinforcer to the intermediate section of the rib.

The second side of the rib may have a length that is greater than that of the intermediate section of the rib, and the greater length of the second side of the rib may increase the length of attachment of the rib to the side wall, e.g. to increase the strength of attachment of the second side of the rib to the side wall.

In at least one embodiment, the rib may be formed from a rib body forming the first side of the rib and the intermediate section, and a separate rib second side member forming the second side of the rib.

The rib body may be joined to the rib second side member along an edge of the web of material forming the intermediate section.

The rib second side member may comprise a bottom or lower end joined to the side wall and a top or upper end joined to the rib body. The bottom end of the rib second member may be welded along its length directly or indirectly to the side wall, and the top end may be welded along its length to the rib body.

In some embodiments, the intermediate section of the rib may be spaced approximately 100-1500 mm above an external surface of the side wall.

Further, in some embodiments, the rib may have a length in the direction of the first and second sides of at least 1 m, e.g. a length of 1 m to 5 m.

The forward end of the side wall may extend diagonally upward and forward to the top end thereof. The first side of the rib may be positioned at or adjacent to the forward end of the side wall along its length.

The second side of the rib may be positioned at or adjacent to the top end of said side wall, and it may extend parallel to the top end along its length.

The top end of the side wall may extend up in a forward direction along a part of its length, and the second side of the rib may extend along said upward extending part of the side wall.

The side strengthening arrangement may further comprise a rail extending along the top end of the side wall for strengthening the top end of the side wall, and the second side of the rib may be mounted on the rail.

The side strengthening arrangement may further comprise one side strengthening member on the side wall spaced rearward of the front edge of the side wall, and each of the first and second sides of the rib may be spaced away from said one side strengthening member, and for example terminate short thereof.

The side strengthening arrangement may further comprise a further side strengthening member on the side wall spaced rearward of said one side strengthening member in a direction towards the rear end of the tray, for strengthening the side wall.

The side strengthening arrangement may comprise a yet further side strengthening member mounted on the side wall at or adjacent to the forward end thereof, and the first side of the rib may be mounted on said yet further side strengthening member.

The rib body, e.g. and in particular an intermediate section of the rib body, may have a length that extends at least 30%, optionally at least 40%, of the length of the yet further side strengthening member.

The rib may be formed of steel and may be welded directly or indirectly to the side wall along each of its first and second sides of the rib. For example, in the forms described above, the rib may be welded along its first side to said yet further side strengthening member on the side wall, and along its second side to the rail on the side wall.

The side strengthening arrangement may further comprise an even yet further side strengthening member on the side wall spaced rearward of the further side strengthening member. The even yet further side strengthening member may extend along the rear end of the side wall for strengthening the rear end of the side wall.

The rail may connect to an upper end of at least one of the side strengthening members, e.g., said one and yet further side strengthening members. In at least one form, the rail may also connect to an upper end of the further and even yet further side strengthening members.

Each of the side strengthening members may be substantially linear and may extend diagonally upward, from one end adjacent the bottom end of the side wall, to another end at the top end of the side wall.

Optionally, the rail on the side wall may comprise a second layer of steel mounted on the side wall of the tray where it forms a double layer of steel, which is called a rail doubler or a side rail doubler. The rail may extend substantially along the full length of the side wall.

The side strengthening members on the side wall may also comprise a second layer of steel mounted on the side wall of the tray forming a double layer of steel, called a side doubler. Each of the side strengthening members may be mounted directly on the side wall with a face-to-face abutment and be fixed to the side wall by welding, e.g. each side strengthening member or side doubler may be welded to the side wall around its full peripheral edge. Each of the side strengthening members may have a width of up to 400 mm and a thickness of up to 50 mm.

Each of the side strengthening members may be located on an external or outer surface of the side wall, that is facing away from the tray. As a result, an inner surface of the tray may be smooth, and free of any projections from the side strengthening members, which smooth surface assists with the flow of particulate load material over the inner surface.

The dump truck body may comprise a front wall extending across the forward end of the side walls, and a front strengthening arrangement on the front wall for strengthening the front wall.

The front strengthening arrangement may comprise at least one front rib extending across at least a part of the front wall between the two side walls.

The at least one front rib may comprise a lower front rib positioned substantially midway up the front wall.

The at least one front rib may further comprise an upper front rib extending across the front wall between the two side walls, towards a top end of the front wall.

Each of the upper and lower front ribs may extend substantially horizontally across a full width of the front wall.

The front strengthening arrangement may further comprise at least one stiffener extending up the front wall in a direction transverse to the or each front rib. The at least one stiffener may comprise two stiffeners extending vertically up the front wall, and the two stiffeners may be parallel to each other and spaced apart from each other.

Each stiffener may comprise a plate or bar of steel that is solid, and extends substantially vertically up the front wall to the upper front rib. Further, each stiffener may be configured to complement the cross-sectional configuration of the lower front rib when it passes over and around the lower front rib to join the upper front rib.

The dump truck body may further comprise a protective canopy extending away from the front wall for covering an operator's cabin of a dump truck in use.

The protective canopy may extend forward from a top end of the front wall and may be rigidly joined to the front wall.

The protective canopy may extend forward from the top end of each side wall, e.g. the top and forward end of each side wall, and may be rigidly joined to each side wall.

The protective canopy may have a rear part at or adjacent the front wall, and the second side of the rib may have a front part at or adjacent the rear part of the protective canopy.

The tray may form a material carrying portion of the dump truck body.

Further, the dump truck body may include any one or more of the features, or combination of features, of a dump truck body defined in any other aspect of the invention.

According to another aspect of the invention there is provided a dump truck body for a dump truck, comprising:
a tray comprising a floor and two side walls extending up from the floor; and
a front wall extending between the side walls on a leading end of the tray, and a front strengthening arrangement on the front wall comprising a front strengthening member.

The front strengthening member may comprise at least one front rib having first and second sides (or edges), and the first and second sides thereof may be mounted on the front wall. For example, the first and second sides of the or each front rib may be welded to the front wall along their lengths.

The front rib may further comprise an intermediate rib section between the first and second sides thereof, that is spaced from an external surface of the front wall.

The or each front rib may extend substantially horizontally across the full width of the front wall.

Further, the front strengthening arrangement may further comprise a lower front rib and an upper front rib spaced above the lower front rib and extending across the front wall.

The lower front rib may be positioned substantially midway up the front wall and the upper front rib may be positioned adjacent the top end of the front wall.

The front strengthening arrangement may further comprise at least one stiffener extending transverse to the front strengthening member up the front wall.

Advantageously, the dump truck body may include two said stiffeners extending vertically up the front wall, the two stiffeners extending parallel to each other and spaced apart from each other.

Conveniently, the two stiffeners may be substantially centrally positioned on the front wall and be closely spaced from each other.

The dump truck body may further comprise a side strengthening arrangement on each side wall for strengthening the side wall.

The side strengthening arrangement may be positioned towards the front end of the side wall.

The dump truck body may include any one or more features, or combination of features, of the truck body defined in another aspect of the invention.

According to another aspect of the invention there is provided a dump truck for use in mining activities comprising a dump truck body as defined in any one of the aspects of the invention, and a truck chassis having ground engaging formations, preferably in the form of wheels, for travelling across the ground, and the dump truck body may be pivotably mounted on the truck chassis so that it can be pivoted up to discharge material from the truck body.

The truck body may further comprise a protective canopy extending away from the front wall for covering an operator's cabin of a dump truck in use.

The protective canopy may extend away from a top end of the front wall and may be rigidly joined to the front wall, and the protective canopy may extend away from the top end of each side wall and may be rigidly joined to each side wall.

The protective canopy may extend forward from the front wall, and the canopy may have a rear part at or adjacent the front wall, and the second side of the rib may have a front part at or adjacent the rear part of the protective canopy.

The truck may further comprise a drive arrangement for driving the ground engaging formations, e.g. wheels.

The truck may further include an operator's cabin in which a truck operator sits when the dump truck is in use.

Further, the dump truck body on the dump truck may include any one or more of the features, or combination of features, of the dump truck body defined in any other aspect of the invention.

According to yet another aspect of the invention there is provided a dump truck body for a dump truck, comprising:
a tray comprising a floor and two side walls extending up from the floor; and
at least one side strengthening arrangement mounted on a side wall,
wherein the/each side strengthening arrangement comprises a rib on the side wall.

The dump truck body may include a side strengthening arrangement on each of the two side walls.

The tray may form a material carrying portion of the dump truck body.

The side strengthening arrangement may further comprise a first side strengthening member and a spaced second side strengthening member on the side wall, and the rib on each side wall may extend between the first and second side strengthening members.

The first side strengthening member may extend diagonally upwards and forwards from a lower end to an upper end.

The side wall of the tray may have a forward end and a rear end, and the first side strengthening member may be positioned at or adjacent the forward end of the side wall.

The side wall may have a top end and the second side strengthening member may extend along the top end of the side wall, e.g. forming a rail.

The rib may comprise first and second sides that are mounted on each of the first and second side strengthening members respectively.

The rib may be made of steel and may be welded to each of the first and second side strengthening members.

The rib may extend from the first to the second side strengthening member spaced above the side wall, and a spaced portion of the rib may extend parallel to the side wall. In an example form, the rib may be spaced 40 mm to 200 mm away from the side wall, e.g. 80-150 mm away from the side wall.

The side strengthening arrangement may further include a third side strengthening arrangement extending parallel to the first side strengthening member and spaced rearward of the first side strengthening member.

The second side strengthening member which forms the rail may join the first and third side strengthening members.

The side wall may be formed of steel and each side strengthening member on the side wall may be formed from a second layer of steel mounted directly on and superimposed with the side wall forming a doubler.

Each of the side strengthening members may be located on an external or outer surface of the side wall facing away from the tray. As a result, an inner surface of the tray remains smooth which assists the flow of particulate load material over the inner surface.

The side strengthening arrangements on the left and right, side walls of the tray, may be the same so that the tray is bilaterally symmetrical.

The dump truck body may further include a front wall extending between the front of each side wall, and a front strengthening arrangement on the front wall.

The front strengthening arrangement may comprise at least one front rib and any one or more of the features, or combination of features, of the front strengthening arrangement defined in any of the other aspects of the invention.

Further, the dump truck body may include any one or more of the features, or combination of features, of the dump truck body defined in any other aspect of the invention.

### BRIEF DESCRIPTION OF THE DRAWINGS

A dump truck body and a dump truck in accordance with the invention may be implemented in several different forms. It will be convenient to hereinafter describe in detail several embodiments of the invention with reference to accompanying drawings. The purpose of providing this detailed description is to instruct persons having an interest in the subject matter of the invention how to carry the invention into practical effect. However, it is to be clearly understood that the specific nature of this detailed description does not supersede the generality of the preceding summary section. The Detailed Description refers to the accompanying drawings, in which:

FIG. 1 is an upper perspective view of a mining truck or dump truck of the general type to which this invention relates;

FIG. 2 is a perspective view of a dump truck body for a dump truck known in the prior art;

FIG. 3 is a close up perspective view of an upper edge of a side wall of the dump truck body in FIG. 2;

FIG. 4 is a perspective view of a generic dump truck body (with other components of the dump truck omitted) in a tipping position for discharging material from the truck body;

FIG. 5 is an upper perspective view of a dump truck body in accordance with a first embodiment of the invention;

FIG. 6 is a lower perspective view of the dump truck body in FIG. 5;

FIG. 7 is a side view of one side of the truck body in FIG. 5 (the other side of the truck body being the same as this side);

FIG. 8a is a close-up perspective view of a part of a side strengthening arrangement of the dump truck body in FIG. 5, and FIG. 8b is a schematic cross-sectional view thereof;

FIG. 9 is a front view of the dump truck body in FIG. 8;

FIG. 10a is a close-up perspective view of the front strengthening arrangement of the dump truck body in FIG. 5, and FIG. 10b is a schematic cross-sectional view thereof;

FIG. 11 is an upper perspective view of a dump truck body in accordance with another embodiment of the invention;

FIG. 12 is a lower perspective view of the dump truck body in FIG. 11;

FIG. 13 is a side view of one side of a dump truck body in accordance with yet another embodiment of the invention;

FIG. 14 is a close-up perspective view of a part of a side strengthening arrangement of the dump truck body in FIG. 13;

FIG. 15 is an exploded perspective view of the part of the side strengthening arrangement in FIG. 14 with some of the details omitted for clarity; and

FIG. 16 is a schematic drawing of a dump truck having a truck body mounted thereon.

### DETAILED DESCRIPTION

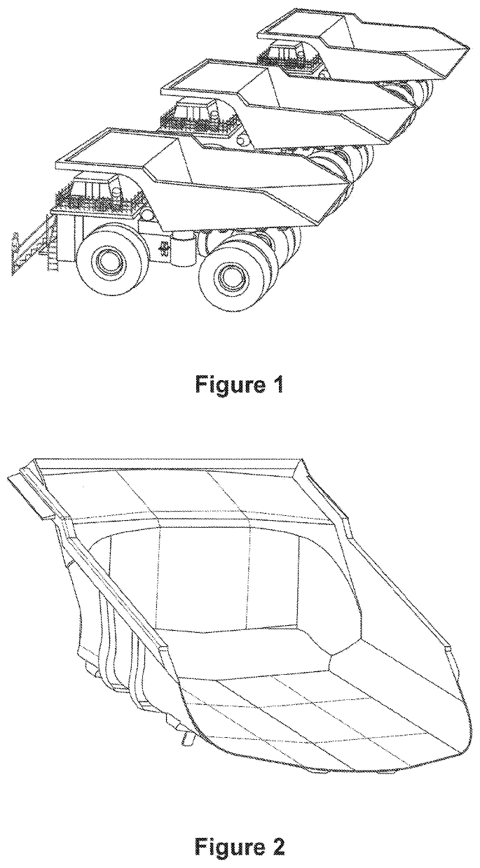

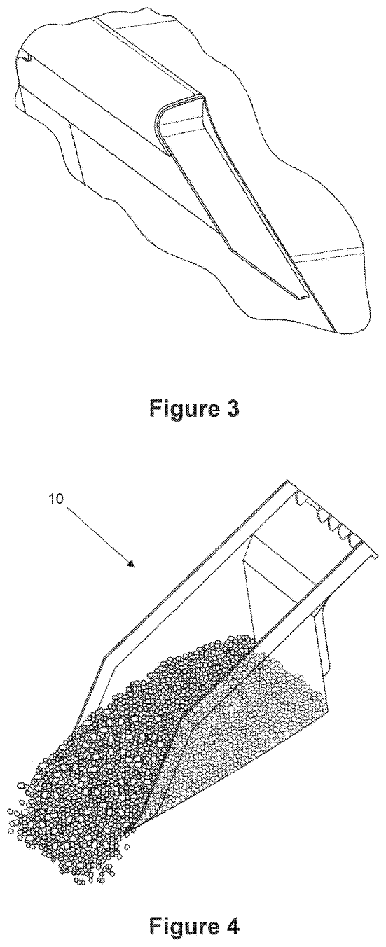

FIG. 1 illustrates a dump truck used for mining and FIGS. 2 and 3 illustrate a dump truck body (known in the prior art) that is used on the dump truck shown in FIG. 1. FIG. 4 shows a basic truck body in a tipping configuration in which it discharges a load of particulate material from its rear. As these dump trucks and dump truck bodies are described in the background section above, and do not form part of the invention disclosed in this application, they will not be described further in the detailed description.

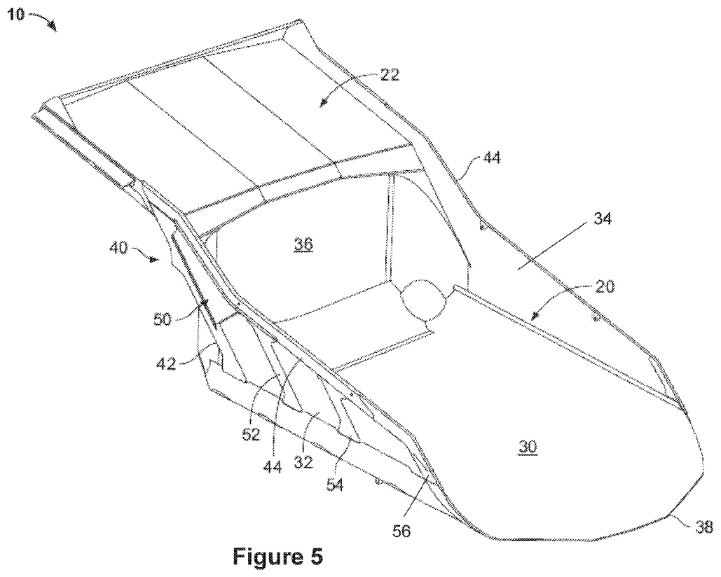

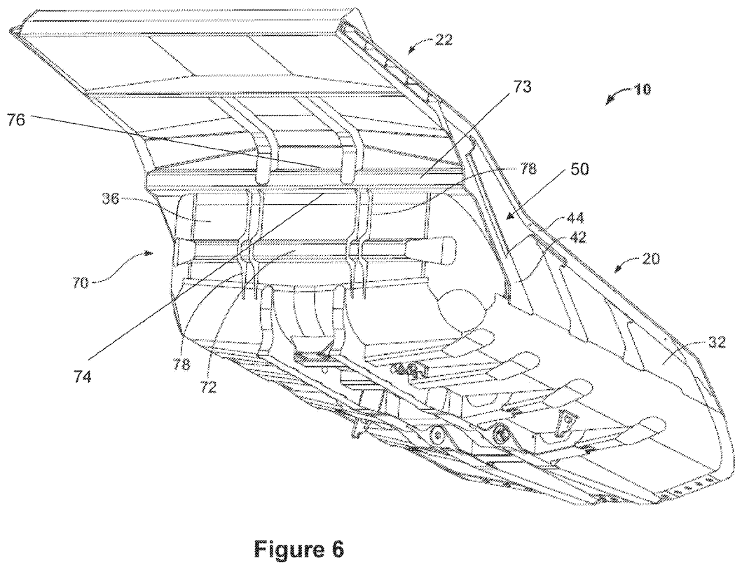

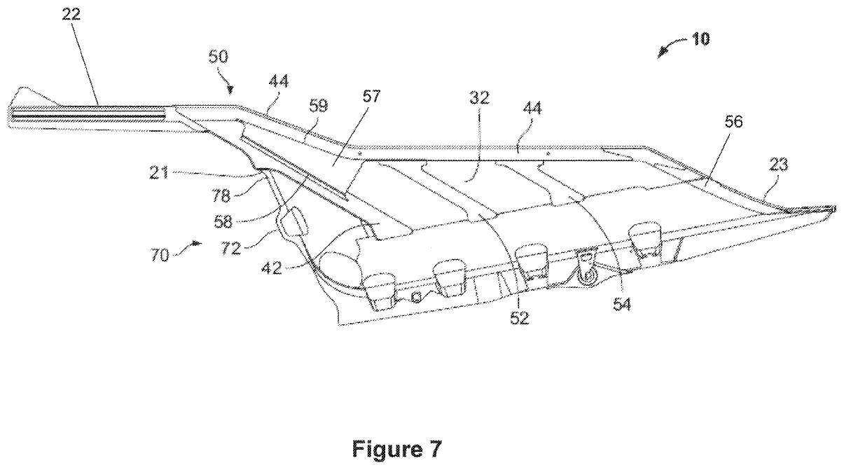

FIGS. 5 to 10 illustrate a dump truck body in accordance with one embodiment of the invention, and in the drawings reference numeral 10 refers generally to the dump truck body.

The dump truck body 10 comprises a tray (or material carrying portion of the body) 20 and a protective canopy 22 extending forward from the tray 20 for extending over an operator's cabin.

The tray 20 in turn comprises a floor 30 having first and second sides extending between a leading end or forward end and an opposed trailing end. The tray 20 has first and second side walls 32 and 34 extending up from the first and second sides respectively of the floor 30, each wall having a forward end 31 and a trailing end 33. The tray 20 further includes a front wall 36 extending across the forward end 31 of the first and second side walls 32 and 34 and the forward end of the floor 30. The tray 20 further includes a tail or tail gate 38 at a rear end thereof through which material is discharged from the tray 20 when the truck body 20 is tipped in use.

The tray 20 further includes a side strengthening arrangement 40 on each side wall 32 and 34 of the truck body 10. The side strengthening arrangements 40 on the first and second side walls 32 and 34 are the same, and accordingly only one such side strengthening arrangement on the side wall 32 will be described in in detail below.

The side strengthening arrangement 40 comprises a rib 50 on the side wall 32 that stiffens the side wall towards the forward end 31 to limit deformation thereof when the tray 20 is loaded with particulate material. Applicant understands that the rib 50 may sometimes be referred to as a bolster in the art of dump truck bodies or mining truck bodies.

The rib 50 comprises a first side 58 that is fixed, directly or indirectly, to the side wall 32 extend diagonally upward in a forward direction along its length, and a second side 59 that is fixed, directly or indirectly, to the side wall 32 spaced from the first side 58. The rib 50 also includes an intermediate section 57 between the first and second sides 58 and 59 that is spaced outward of an external surface of the side wall 32 (and does not contact the side wall).

The intermediate section 57 comprises a web or sheet of material that extends between the first and second sides and the first and second sides 58 and 59 of the rib 50 extend along opposed edges of the web or sheet of material.

The intermediate section 57, and the first and the second sides 58 and 59 of the rib 50 together with a part of the side wall 32 between the first and second sides 58 and 59, define or form an elongate space therebetween.

In at least one example form, the intermediate section 57 of the rib 50 is spaced approximately 100-1500 mm away from or outward of the external surface of the side wall 32. Further, in at least one example form, the rib 50 has a length in the direction of the first and second sides 58 and 59 of at least 1 m, e.g. 1 m to 2.5 m.

The forward end 31 of the side wall 32 extends diagonally upwards and forwards from a lower end or bottom of the side wall 32 to an upper end or top thereof. The first side 58 of the rib 50 extends substantially parallel to the forward end 31 of the side wall 32 along its length and is positioned at or adjacent to the forward end of the side wall 32.

In the illustrated embodiment, the second side 59 of the rib 50 also extends diagonally upward in a forward direction along its length. An upper edge or top end of the side wall 32 extends upwards and forwards along a part of its length, and the second side 59 of the rib 50 extends along said upward extending part. In the illustrated embodiment, the first and second sides 58 and 59 of the rib 50 converge along their length in a forward direction and are not parallel to each other along their length.

The side strengthening arrangement 40 further comprises a rail 44 extending along the top end or upper edge of the side wall 32 that is mounted on the side wall 32 by welding. In the illustrated embodiment, the rail 44 extends at least from the front wall 36 (or forward end 31 of the side wall 32) through to the tail or tailgate 38 (at the rear end 33 of the side wall). The second side 59 of the rib 50 is mounted on the rail 44 by welding.

The side strengthening arrangement 40 further comprises a first side strengthening member 42 (also called a yet further side strengthening member) mounted on the forward end of the side wall 32 extending diagonally upward in a forward direction from a lower end up to the rail 44 on the top end of the side wall 32. The first side 58 of the rib 50 is welded onto the first side strengthening member 42. In one example embodiment which is illustrated in the drawings, the first side 58 of the rib 50 has a length that is at least 40% of the length of the first side strengthening member 42 and/or forward end of the side wall 32.

Thus, the rib 50 is positioned at or adjacent to the forward end 31 of the side wall 32, and extends from the first side strengthening member 42 across a surface of the side wall 32 to the rail 44 extending along the top end of the side wall 32 as shown in the drawings.

In the illustrated embodiment, the side strengthening arrangement 40 further comprises a second side strengthening member 52 (also called ‘one side strengthening member’) positioned rearward of the first side strengthening member 42 and spaced away therefrom.

The side strengthening arrangement 40 further comprises a third side strengthening member 54 (also called ‘a further side strengthening member’), positioned rearward of the second side strengthening member 52 and spaced away therefrom. Further, the side strengthening arrangement 40 comprises a fourth side strengthening member 56 (also called ‘an even yet further side strengthening member’) positioned rearward of the third side strengthening member 54 and spaced away therefrom.

The side strengthening members 42, 52, 54 and 56 extend substantially parallel to each other and may be spaced substantially equidistantly from each other. Each of the side strengthening members 42, 52, 54 and 56 is linear and extends up at an inclined angle, from an operatively lower end thereof to an operatively upper end at an angle of about 30 to 60 degrees to horizontal. An operatively upper end of each side strengthening member 42, 52, 54, and 56 is closer to the front wall 36 than an operatively lower end thereof as shown in the drawings.

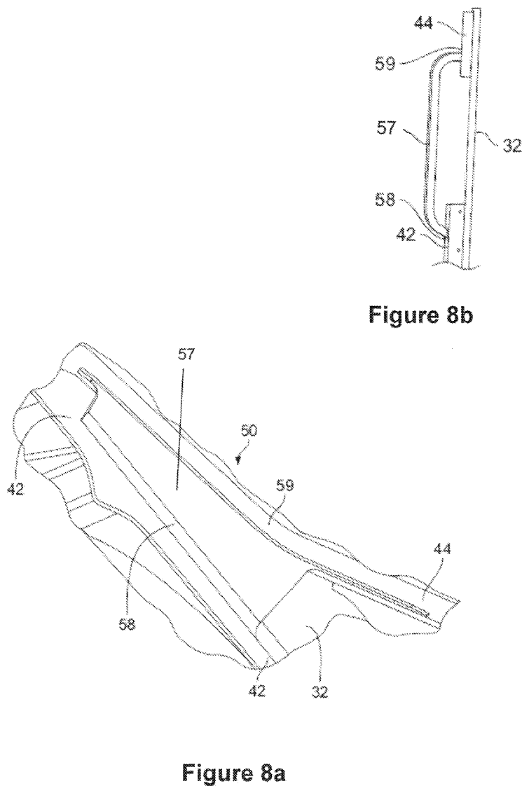

The rib 50 comprises a rib body 51 in the form of a pressed section of steel, e.g. of a reinforced and/or high tensile steel, having its first longitudinal side or edge 58 joined to the first side strengthening member 42 by welding, and its second longitudinal side or edge 59 joined to the rail 44 by welding. Further, the rib 50 has a length or longitudinal extent in a direction of the first side strengthening member 42 (and the first and second sides of the rib 50) that is approximately 30 to 50% of the length of the side strengthening member 42. An example structure of the rib 50 including its cross-sectional configuration is shown schematically in FIGS. 8a and 8b.

The rib 50 therefore provides some additional strength to a region of the side wall 32 while still permitting other regions of the side wall 32 to flex to some extent. The rib 50 provides this additional strength towards a top and forward end of the side wall 32 where the side wall joins the front wall 36 and the protective canopy 22.

The side wall 32 (which is lighter than the side walls of prior art dump truck bodies) confers greater flexibility on the dump truck body which is advantageous in certain respects as discussed elsewhere. However, the forward end 31 of the side wall 32 joins the front wall 36, while the canopy 22 joins the forward end 31 of the side wall 32 (in an upper region of the side wall 32), and the front wall 36. Consequently, three different components are interconnected in this region of the truck body, and this limits the ability of the truck body 10 to flex. To address this, the side wall 32 needs to be stiffened in this region to resist cracking of welds joining these components to each other. The side strengthening arrangement 40 illustrated in the drawing has been found to be highly effective at achieving this.

The rail 44 on the side wall 32 comprises a second layer of steel mounted on the external surface of the side wall 32 where it forms a double layer of steel (called a side rail doubler) that extends substantially along the full length of the side wall 32. The rail 44 stiffens and strengthens an upper edge of the side wall 32 in a similar way to which the first to third side strengthening members 42, 52, and 54 strengthen the side wall 32.

As with the rail 44, the first to fourth side strengthening members 42, 52, 54 and 56 on the side wall 32 each comprise a second layer or plate of steel that is mounted on the steel plate of the side wall forming a double layer of steel, (called a side doubler). Each of the first to fourth side strengthening members 42, 52, 54 and 56 is mounted directly on the side wall 32 (with a face-to-face abutment of the plate steel of the strengthening member on the side wall) and is fixed to the side wall 32 by welding.

Each side strengthening member 42, 52, 54, and 56 is welded around its peripheral edge to an adjacent external surface of the side wall 32. Each side doubler effectively creates a double layer of steel which strengthens the side wall 32 of the tray 20.

The second piece of steel forming the side doubler or side rail doubler typically has a thickness that is greater than the thickness of the basic side wall. The extent to which the second or upper piece of steel is thicker than that if the underlying wall can vary. In some example forms, the second piece of steel has a thickness of 1.5 times to 2.5 times the thickness of the underlying side wall. In some applications, the Applicant envisages that the underlying wall may have a thickness of 10 mm or 12 mm, and the second piece of steel may have a thickness of 16-50 mm, preferably 16-25 mm. Further, in some applications, the side doublers may have a width of up to 400 mm. However, it will be appreciated that specific thicknesses will depend on the size and engineering requirements of a specific truck body.

The truck body 20 further includes a front strengthening arrangement 70 for strengthening the front wall 36 so that it does not deform excessively when it is loaded with material to be carried. The front strengthening arrangement 70 comprises a front strengthening member in the form of a lower front rib 72 extending from one side of the front wall 36 to the other and an upper front rib 73. The lower front rib 72 is positioned substantially midway up the front wall 36, and it extends substantially horizontally across a full width of the front wall 36.

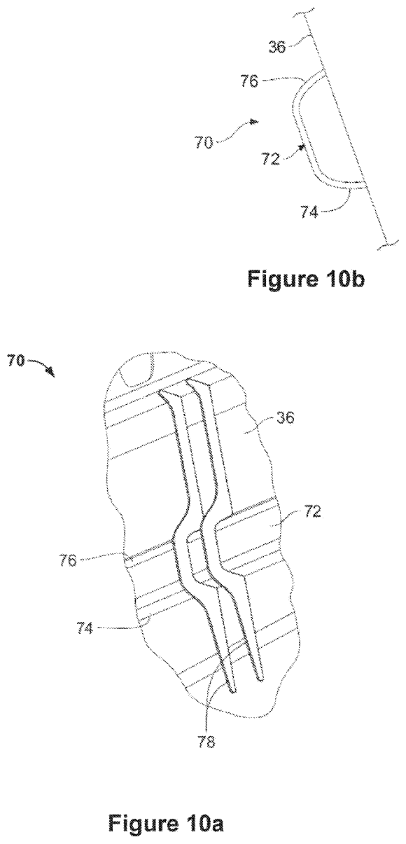

As with the rib 50 on the side walls 32 and 34, the front rib 72 comprises a first side 74 that is fixed to the front wall 36, and a second side 76 that is fixed to the front wall 36 spaced from the first side 74, and an intermediate section 57 between the first and second sides 74 and 76 that is spaced away from the front wall 36. Conveniently, the front rib 72 may be formed by a pressed or rolled section of steel and its longitudinal first and second sides 74 and 76 are each mounted to the front wall 36 by welding along their full lengths. Further, rib end caps are welded onto the ends of the front rib 72. FIG. 10 provides a schematic drawing of the front rib 72 showing its cross-sectional shape, and its welding onto an outer or external surface of the front wall 26.

The upper front rib 73 extends across the front wall 36 adjacent its top end and this helps to stiffen an upper end of the front wall 36.

The front strengthening arrangement 70 further comprises two stiffeners 78 extending transverse to the lower front rib 72 and the upper front rib 73 that extend vertically up the front wall 36, i.e. the stiffeners 78 do not extend diagonally or in a slanted manner up the front wall 36. The two stiffeners 78 extend parallel to each other, and are closely spaced apart from each other, as they travel up the front wall 36 to the upper front rib 73 adjacent the top end. The stiffeners 78 also help to stiffen the front wall 26 up its full height and keep deformation of the front wall 36 (which has some flexibility) within acceptable limits. Each stiffener 78 comprises a substantially linear plate or bar or section of solid steel, that is configured to bear up against the external surface of the front wall 36 and has a different structure of the lower front rib 72. An edge of the plate or bar is placed in face-to-face contact with the external surface of the front wall 36. In the illustrated embodiment, each stiffener 78 is configured to extend over and around the lower front rib 72 and lie up against the front wall 36.

The lower front rib 72, upper front rib 73, and stiffeners 78, work together to effectively stiffen the front wall 36 to limit deformation thereof when the tray 20 is filled with an internal load which applies an outward directed force to the front wall 36 (recognizing that the steel plate forming the front wall 36 is thinner and has more flexibility (than the front walls of some prior art truck bodies).

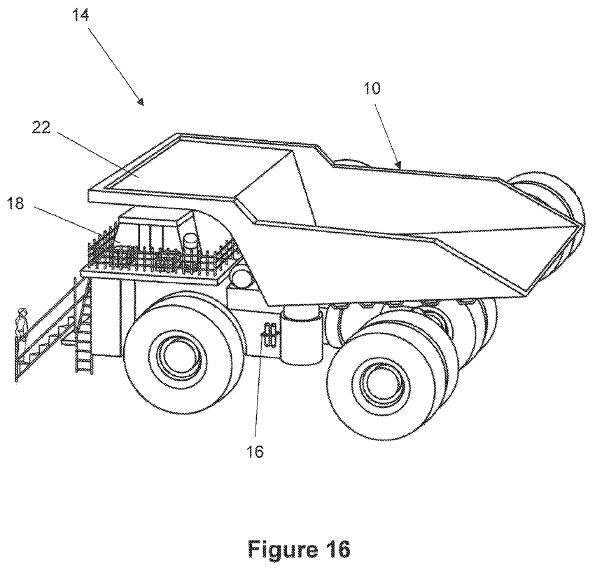

A dump truck including the disclosed truck body is like that shown in FIG. 16 with the exception that the truck body (which is shown only in a very diagrammatic or schematic way in FIG. 16 with many details omitted) is replaced with the truck body described above with reference to FIGS. 5 to 9. The truck bodies are interchangeable on the trucks, and the truck body illustrated in FIG. 5 should be read as being mountable on the truck shown in FIG. 16.

In use, the mining dump truck 14 is used to transport particulate material from a loading location to a dumping location on the truck body 10. The dump truck 14 comprises a truck chassis 16 with wheels for displacing the mining dump truck 14 over the ground and an operator's cabin 18 mounted on the truck chassis 16. The truck body 10 is also mounted on the truck chassis 16 and the protective canopy 22 thereof extends forward over the operator's cabin 18 to protect an operator within the cabin 18.

At a loading location, a loading vehicle such as a front loader (not shown), is used to gather up particulate material, lift the particulate material up above the level or height of the tray 20 of the truck body 10, and then dump it into the tray 20. Instead of a loader, an excavator, face shovel, or dipper or the like may also be used to load the particulate material into the tray 20. The mining dump truck 14 then travels to the dumping location where it dumps the material. It does this by tilting or pivoting up the tray 20 on the truck chassis 16 to cause the material to discharge from the tray 20 through the tailgate 38.

In operation, mine operators typically seek to load up each of their dump truck bodies 10 with as large a payload as possible. This increases the productivity of the associated dump trucks 14 and consequently the overall efficiency of the related mining operation. The dump truck body 10 illustrated in FIGS. 5 to 10 has more structural flexibility than the prior art truck bodies described in the background section and is lighter than the truck bodies described in the background section. This is due to the tray having a steel wall that is not as thick as those in the prior art truck bodies. The introduction of structural flexibility into the design enables the weight of the truck body 20 to be reduced, while still retaining a suitable and appropriate structural strength to perform the intended task. It may also enable the internal volume of the truck body to be increased. This therefore enables the truck body 20 to carry a greater payload.

The side and front strengthening arrangements 40 and 70 respectively, can stiffen and strengthen the truck body 10 in those regions that are subject to high load (and pressure to deform) to keep the deformation within acceptable limits. These areas comprise the forward end of the side wall and the front wall. The truck body achieves this at all stages of use including loading the truck and dumping the load.

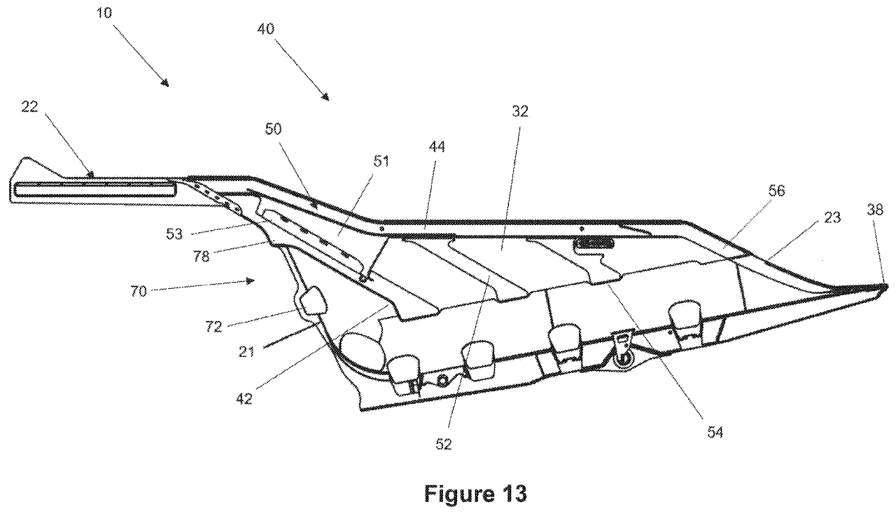

FIGS. 13 to 15 illustrate a dump truck body in accordance with another embodiment of the invention. This embodiment has several similarities to the embodiment described above with reference to FIGS. 5 to 8 and accordingly, the same reference numerals will be used to refer to the same components unless otherwise illustrated. Further, the description below will focus on the differences between this embodiment and the earlier embodiment.

FIG. 13 shows a side strengthening arrangement 40 on the side wall 32 of the dump truck body 10. The side strengthening arrangement 40 comprises a rib 50 extending diagonally up to a top end of the side wall 32 at a forward end 21.

The rib 50 comprises a first side 58 adjacent the forward end of the side wall 32 and a second side 59 adjacent the top end of the side wall 32. The first side 58 is mounted on a first side strengthening formation 42 (a side doubler) on the side wall 32 and the second side is mounted on the rail 44 (another side doubler or rail doubler) extending along the top end of the side wall 32 along its length.

The rib 50 comprises a pressed rib body 51 extending from the first side 58 of the rib 50 to the second side 59. The rib body 51 has a first side forming the first side 58 of the rib 50 and extends across to a second side that is adjacent the second side 59. The rib 50 further comprises a rib second side member 56 forming the actual second side 59 of the rib 50. The side member 56 extends up from the side wall 32 to the second side of the rib body 51 which it joins.

In the illustrated embodiment, the pressed rib body 51 comprises a curved first side which bends down or curves down towards the side wall 32 and is welded to the side wall 32 along its length.

The second side of the rib body 51 is welded to an upper end of the rib second side member 56 along its length. A lower end of the rib second side member 56 is welded to the side wall 32 along its length. Thus, in the illustrated embodiment the rib 50 comprises a rib body pressing 51 forming a pressed first side, and the rib second side member 56 forming a fabricated second side.

An external rib reinforcer (in the form of a rib doubler) 53 is mounted on an external surface of the rib body 51. The external rib doubler 53 is welded to the side wall 32 and extends up and over an external surface of the rib body 51. The external rib doubler 53 is welded to the external surface of the rib body 51 along its peripheral extent that is in contact with the rib body 51.

Further, the external rib doubler 53 has a plurality of internal apertures formed therein (four weld apertures being shown in the illustrated example embodiment) that provide additional length for welding of the rib doubler 53 to the rib body 51. In the illustrated embodiment, the rib doubler 53 extends less than halfway across the width of the rib body 51 from the first to the second sides thereof.

The rib second side member 56 has a longitudinal length that is longer than the length of the rib body 51 and, in the illustrated embodiment, it projects axially outward beyond each end of the rib body 51. This additional length of contact between the rib second side member 56 and the side wall 32 provides additional length for welding the side member 56 to the side wall 32 thereby confers additional strength.

The first side of the rib body 51 is also axially lengthened at one end thereof. This is done for the same reason, namely for increasing the path length for welding thereof to the side wall 32.

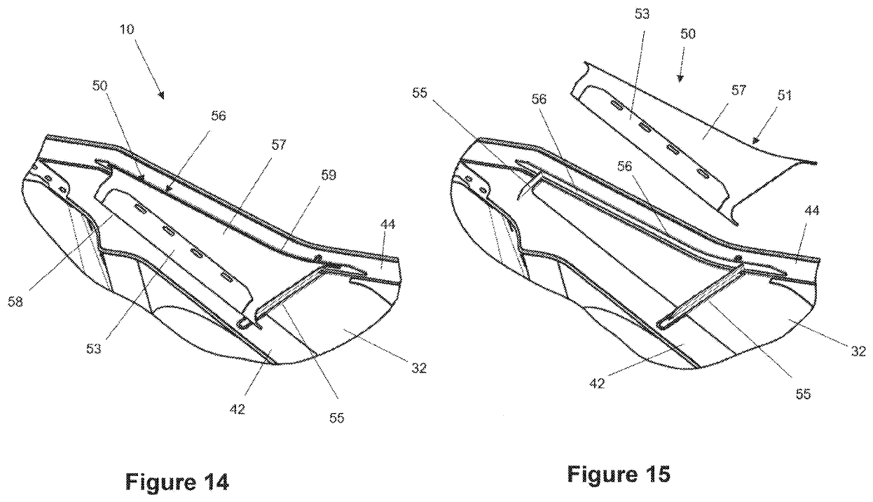

As shown in more detail in FIGS. 14 and 15, the rib body 51 has open ends and the rib 50 further comprises rib end caps 55 that close off the open ends of the elongate space (formed by the intermediate section and the first and second sides of the rib). Each rib end cap 55 is configured to substantially match its associated open end of the rib body 51 and close off the open end. Each rib end cap 55 is welded to the side wall 32 along its bottom end, and to the rib body 52 and the rib member 56 along its sides and its top end. That is, each rib end cap 55 is welded to surrounding structure around its full peripheral extent. The rib end caps 55 contribute to strengthening the rib 50 and associated side wall to enable it to withstand high forces in use.

Another feature of the rib end caps 55 is that they are received back or recessed back from the longitudinal ends of the rib body 51 and the side member 56 (rather than being aligned with longitudinal ends of the rib body 51). This feature creates a line along the rib end cap 55 facing outward that can be welded to the rib body 51 to create additional weld length.

Further in the embodiment illustrated in FIGS. 14 and 15, the first side strengthening member 42 (side doubler on the side wall) has a U-shaped recess formed therein at a point along its length into which the rib end cap 55 extends. This feature which is shown most clearly in FIG. 15 (which omits the rib doubler 53) provides for additional weld length for welding the end cap 55 directly to the side wall 32 (in the space formed by the recess) and strengthening the weld connection to the side wall 32.

The external rib doubler 51 and the rib end caps 55 confer additional strength on the rib 50 to enable the side strengthening arrangement 40 to withstand the large forces to which they are exposed in use.

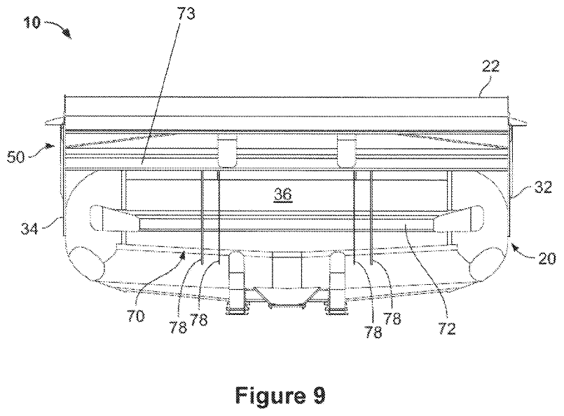

In this embodiment, the front strengthening arrangement 70 (which is not shown) may be the same as that described above with reference to the first embodiment and illustrated in FIGS. 9 and 10.

In use, the side strengthening arrangement 40 illustrated in FIGS. 13 to 15 functions in a similar way to that described above with reference to FIGS. 5 to 8.

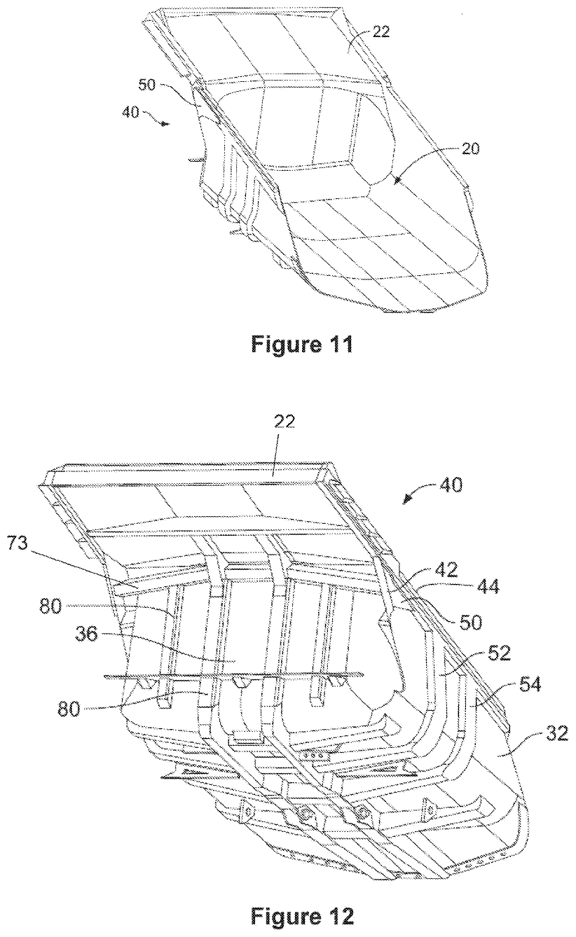

FIGS. 11 and 12 illustrate a truck body in accordance with a yet further embodiment of the invention. Unless otherwise indicated, the same reference numerals will be used to refer to the same components. This truck body has many similarities with the truck body 10 in FIGS. 5 to 10, and the following description will focus on the differences between this truck body and that in the earlier embodiment.

In FIGS. 11 and 12, the truck body 10 has side strengthening arrangements 40 on each side wall 32, 34 of the dump truck body 10 that are the same as those in the FIG. 5 embodiment. These side strengthening arrangements 40 act to strengthen the side walls 32 and 34 of the tray 20 in those key areas identified to limit their deformation when the tray 20 is subject to high loads in use.

However, the embodiment in FIGS. 11 and 12 does not have a front strengthening arrangement like the front strengthening arrangement 70 in FIGS. 5 to 10. Essentially, the front wall 36 of the tray 20 is designed to be sufficiently sturdy to resist excessive deformation in use without the front strengthening arrangement shown in FIG. 5.

Instead, the illustrated embodiment in FIGS. 10 and 11 has a plurality of vertically extending strengthening members 80 mounted thereon. The vertical members 80 are spaced apart from each other across a width of the front wall 36 and join an upper rib towards an upper end of the front wall 36. Essentially, the front wall 36 together with the plurality of vertically extending strengthening members 80 is engineered to limit deformation notwithstanding the absence of the front rib 72 and the stiffeners 78 shown in the first embodiment.

In yet another embodiment of the truck body that has not been illustrated, the dump truck body 10 has a front strengthening arrangement which acts to resist deformation of the front wall 36 when the tray is loaded with material. In this other embodiment, the front strengthening arrangement is the same as that illustrated in FIGS. 5 to 10.

However, this embodiment does not have side strengthening arrangements 40 on the side walls 32 and 34 of the tray 20 shown in FIG. 5. Essentially, an upper region at the forward end of the side wall is designed and engineered to be sufficiently sturdy to resist excessive deformation thereof in use.

One working advantage of the embodiment described above with reference to FIGS. 5 to 10 of the drawings is that it is lighter than some prior art truck bodies, but still has sufficient strength to limit its deformation when loaded up with material. The novel and unique side strengthening arrangements of this embodiment are effective at limiting deformation of the tray in the key areas of the forward end of the side walls in use when the tray is fully loaded.

The lighter weight of the truck body enables a greater weight of payload to be carried without exceeding a GVM weight limit. Further, the lighter truck body also typically enables a truck body with a greater internal volume to be received within a design envelope (or outer dimensional envelope) for that truck which depends on the requirements of the truck on which the truck body is to be fitted. Bear in mind that different OEM trucks have different dimensional requirements.

Both these factors help to increase the payload of material that can be carried by the truck. This in turn can enhance the productivity of a mining operation and provide significant revenue gains.

Another advantage of the embodiment described above with reference to FIGS. 5 to 10 of the drawings is that the truck body is not repaired during its lifetime. Once the truck body wears out, it is taken out of service and replaced with a new truck body. This avoids the need for periodic maintenance on the truck body, either to replace wear liner systems on the body or to cut out and replace worn steel sections of the tray body. The replacement of liner systems on truck bodies takes trucks out of service and is time consuming and expensive. Similarly repairing sections of a truck body also take s the truck out of service and is time consuming and expensive.

Yet another advantage of the truck described above with reference to FIGS. 5 to 10 is that the side and front strengthening arrangement are located on an external or outer surface of the tray. As such, an inner surface of the tray is smooth which is preferable for material flow in the tray. It also avoids any encroachment on the internal volume of the tray. By contrast, replaceable liner systems do encroach on the interior space of the try and they also interfere with material flow across the floor of the tray.

Further, the side and front strengthening arrangements are not unduly complex and can be fabricated at reasonable cost. Therefore, the truck body in FIG. 5 can be supplied to customers at a competitive cost.

In this specification, the term ‘rib’ shall be understood in its conventional engineering sense, and it shall also be understood to mean a member having first and second sides and an intermediate section extending between the first and second sides. In use, the first and second sides are mounted on an external structure, such as a wall, and the intermediate section is spaced from the wall so it can bend and flex while still providing structural support. The term rib includes within its scope a structure where the intermediate section extending between the first and second sides section comprises a web or sheet of material extending between the first and second sides and the first and second sides extend along opposed edges of the web or sheet of material. The rib contemplated in this specification may also be known as a bolster in the dump truck art.

In this specification, the term ‘truck body’ shall be interpreted broadly and shall include a dump truck body of the type used in the mining industry that is loaded with material to be transported, and that dumps the material by tipping the truck body.

In this specification, the term ‘mounted on the side wall’ shall be interpreted broadly and shall be construed to include being mounted directly or indirectly on the side wall. This term would include within its scope mounting a component on a side strengthening member which in turn is mounted on the side wall.

In this specification, the term ‘comprising’ is intended to denote the inclusion of a stated integer or integers, but not necessarily the exclusion of any other integer, depending on the context in which that term is used. This applies also to variants of that term such as ‘comprise’or ‘comprises’.

It is intended that all matter contained in the above description or shown in the accompanying drawings shall be interpreted as illustrative only and not limiting. All such modifications and variations thereto, as would be apparent to persons skilled in the art, are deemed to fall within the broad scope and ambit of the invention as is set forth herein. Changes in detail or structure may be made without departing from the basic elements of the invention as defined in the following claims.

1. A dump truck body for a dump truck, comprising:
a tray comprising a floor and two side walls extending up from the floor, each side wall comprising a forward end, a rear end, and a top end extending along a top of the side wall from the forward to the rear ends; and
a side strengthening arrangement on each side wall,
wherein each side strengthening arrangement comprises a rib mounted on the side wall to stiffen the side wall at the forward end;
wherein the rib comprises a first side joined to the side wall, and a second side that is joined to the side wall, and an intermediate section between said first and second sides of the rib that is outward of the side wall, and the first side of the rib extends along the forward end of the side wall, and the second side of the rib extends along the top end of the side wall.

2. (canceled)

3. The dump truck body according to claim 1, wherein the intermediate section comprises a web or sheet of material extending between the first and second sides; and the first and second sides extend along opposed edges of the web or sheet of material.

4. (canceled)

5. The dump truck body according to claim 3, wherein the intermediate section, the first and the second sides and a part of the side wall between the first and second sides, together define an elongate space therebetween.

6. (canceled)

7. (canceled)

8. The dump truck body according to claim 1, wherein the side strengthening arrangement further comprises an external rib reinforcer mounted on and extending across an external surface of the rib.

9. The dump truck body according to claim 8, wherein the external rib reinforcer extends across the first or second side of the rib and a part of the intermediate section thereof, and the external rib reinforcer is welded around its peripheral edge to the first or second side of the rib and to the side wall.

10. (canceled)

11. (canceled)

12. The dump truck body according to claim 1, wherein the second side of the rib has a length that is greater than that of the intermediate section of the rib, and the greater length of the second side of the rib increases the length of attachment of the rib to the side wall.

13. The dump truck body according to claim 1, wherein the rib is formed from a rib body comprising the first side of the rib and the intermediate section, and a rib second side member comprising the second side of the rib, and the rib body joins the rib second side member on an edge of an web of material running along the second side of the rib.

14. (canceled)

15. (canceled)

16. The dump truck body according to claim 1, wherein the side strengthening arrangement further comprises a rail extending along a top end of the side wall for strengthening the top end of the side wall, and the second side of the rib is mounted on the rail.

17. (canceled)

18. The dump truck body according to claim 1, wherein the side strengthening arrangement further comprises one side strengthening member on the side wall spaced rearward of the forward end of the side wall, and each of the first and second sides of the rib are spaced away said one side strengthening member.

19. The dump truck body according to claim 18, wherein the side strengthening arrangement further comprises a further side strengthening member on the side wall spaced rearward of the one side strengthening member in a direction towards the rear end of the tray.

20. The dump truck body according to claim 32, further comprising a rail extending along a top end of the side wall; wherein the rail connects to an upper end of at least the one and further side strengthening members.

21. The dump truck body according to claim 20, comprising a front wall extending across the forward end of the side walls, and a front strengthening arrangement on the front wall.

22. The dump truck body according to claim 21, wherein the front strengthening arrangement comprises at least one front rib extending across at least part of the front wall between the two side walls.

23. The dump truck body according to claim 22, wherein the at least one front rib comprises two vertically spaced ribs, and each of the vertically spaced ribs extends across the front wall between the two side walls.

24. The dump truck body according to claim 22, wherein the front strengthening arrangement further comprises at least one stiffener extending up the front wall in a direction transverse to each front rib.

25. The dump truck body according to claim 1, wherein the dump truck body further comprises a protective canopy extending away from a front wall for covering a cabin of a dump truck in use.

26. The dump truck body according to claim 25, wherein the protective canopy extends forward from a top end of the front wall and is rigidly joined to the front wall, and the protective canopy extends away from the top end of each side wall and is rigidly joined to each side wall.

27. A dump truck comprising:
the dump truck body of claim 1, and
a truck chassis having ground engaging formations for travelling across the ground, and the dump truck body is pivotably mounted on the truck chassis; wherein, when the dump truck body is pivoted up, material is discharged from the truck body.

28. (canceled)

29. A dump truck body according to claim 1, wherein the second side of the rib extends from the forward end of the side wall partially along the top end of the side wall.

30. A dump truck body according to claim 1, wherein the first side of the rib is linear, and the second side of the rib is also linear, and the first and second sides of the rib converge along their lengths in a forward direction.

31. A dump truck body according to claim 1, wherein the rib has opposed ends that extend between the first and second sides, and the rib comprises a single continuous piece of material in a direction of length from one end to the opposed end.

32. A dump truck body according to claim 19, wherein the side strengthening arrangement further comprises a yet further side strengthening member mounted on the forward end of the side wall, and the first side of the rib is mounted on said yet further side strengthening member.
